(19) United States
(12) Patent Application Publication
(10) Pub. No.: US 2005/0272622 A1
(43) Pub. Date: Dec. 8, 2005

(54) Thickened abrasive cleaner

(75) Inventors: Ramakrishnan Hariharan, Montvale, NJ (US); Robert Zhong Lu, Montvale, NJ (US)

Correspondence Address: NORRIS, MCLAUGHLIN & MARCUS, 875 THIRD AVE, 18TH FLOOR, NEW YORK, NY, 10022, US

(73) Assignee: Reckitt Benckiser Inc Morris Corporate Center IV, Parsippany, NJ (US)

(21) Appl. No.: 10/530,372

(22) PCT Filed: Oct. 10, 2003
(86) PCT No.: PCT/GB03/04416

§ 371 Date: Apr. 6, 2005

(30) Foreign Application Priority Data
Oct. 12, 2002 (GB) 02238384

(51) Int. Cl. C11D 1/00

(52) U.S. Cl. 510/267

(57) ABSTRACT

Disclosed are aqueous liquid thickened cleaning and/or disinfecting composition comprising: an alkaline source; at least one surfactant selected from anionic surfactants, non-ionic surfactants, and mixtures thereof; at least one thickener selected from polysaccharides, polycarboxylates, polyacrylamides, clays, and mixtures thereof; a solvent selected from alcohols, glycol ethers, and mixtures thereof; at least one abrasive material optionally, one or more materials selected from perfumes and perfume stabilizers, builders, rheology stabilizers; pH and buffering agents, electrolytes, pigments, colorants and the like. Also disclosed are processes for cleaning and/or disinfection of surfaces, especially hard surfaces, wherein the presence of Gram positive type pathogenic bacteria and/or Gram negative type pathogenic bacteria are suspected.

The present invention relates to cleaning and/or disinfectant compositions for hard surfaces and articles on which the presence of bacteria is suspected.

Accordingly it is an object of the invention to provide a cleaning and/or disinfectant composition that is particularly useful in the disinfection of surfaces where bacteria is suspected.

Accordingly, a further object of the invention is a process for the cleaning and/or disinfection of surfaces, especially hard surfaces, wherein the presence of Gram positive type pathogenic bacteria and/or Gram negative type pathogenic bacteria are suspected.

The present invention relates to a liquid thickened cleaning and/or disinfecting composition comprising:
an alkaline source;
at least one surfactant selected from anionic surfactants, non-ionic surfactants, and mixtures thereof;
at least one thickener selected from polysaccharides, polycarboxylates, polyacrylamides, clays, and mixtures thereof;
a solvent selected from alcohols, glycol ethers, and mixtures thereof;
at least one abrasive material selected from oxides, carbonates, quartzes, siliceous chalk, diatomaceous earth, colloidal silicon dioxide, alkali metasilicates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or talc and mixtures thereof;
water; and
optionally, one or more materials selected from perfumes and perfume stabilizers, builders, rheology stabilizers; pH and buffering agents, electrolytes, pigments, colorants and the like.

The alkaline source can be alkali metal hydroxide, carbonate, bicarbonate, and mixtures thereof.

The compositions of the present invention are useful in cleaning and/or disinfecting hard surfaces.

The surfactant selected from anionic surfactant, non-ionic surfactant, and mixtures thereof is generally present in the composition of the present invention in an amount of from about 0.01 to about 20 wt %. The alkaline source is generally present in the composition of the present invention in an amount of from about 0.01 to about 2 wt %. The thickener is generally present in the composition of the present invention in an amount of from about 0.1 to about 10 wt %. The solvent is generally present in the composition of the present invention in an amount of from about 0.1 to about 10 wt %. The abrasive material is generally present in the composition of the present invention in an amount of from about 1 to about 40 wt %.

It has been found an inventive combination of an alkaline source (e.g. and not limited to, hydroxides (e.g. and not limited to sodium hydroxide and potassium hydroxide), carbonates (e.g. and not limited to sodium carbonate), bicarbonates (e.g. and not limited to sodium bicarbonate), and mixtures thereof) and an alcohol, glycol ether, or mixture thereof (e.g. and not limited to, respectively, benzyl alcohol, propylene glycol phenyl ether, ethylene glycol monohexyl ether, or any combination thereof) provides good broad spectrum germicidal efficacy against both Gram positive and Gram negative bacteria and/or good cleaning on hard surfaces and the like.

The surfactant selected from anionic surfactant, non-ionic surfactant, and mixtures thereof is generally present in the composition of the present invention in an amount of from about 0.01 to about 20 wt %. The alkaline source is generally present in the composition of the present invention in an amount of from about 0.01 to about 2 wt %. The thickener is generally present in the composition of the present invention in an amount of from about 0.1 to about 10 wt %. The solvent is generally present in the composition of the present invention in an amount of from about 0.1 to about 10 wt %. The abrasive material is generally present in the composition of the present invention in an amount of from about 1 to about 40 wt %.

It has been found an inventive combination of an alkaline source (e.g. and not limited to, hydroxides (e.g. and not limited to sodium hydroxide and potassium hydroxide), carbonates (e.g. and not limited to sodium carbonate), bicarbonates (e.g. and not limited to sodium bicarbonate), and mixtures thereof) and an alcohol, glycol ether, or mixture thereof (e.g. and not limited to, respectively, benzyl alcohol, propylene glycol phenyl ether, ethylene glycol monohexyl ether, or any combination thereof) provides good broad spectrum germicidal efficacy against both Gram positive and Gram negative bacteria and/or good cleaning on hard surfaces and the like.

Desirably the total amount of a solvent selected from alcohol (e.g. and not limited to benzyl alcohol), glycol ether (e.g. and not limited to propylene glycol phenyl ether), or combination thereof (e.g. and not limited to benzyl alcohol and propylene glycol phenyl ether) present in the composition is from about 0.1 to about 10 wt %, more desirably in an amount of from about 0.5 to about 8% by weight. While increasing the amount of alcohol or glycol ether generally results in an increase in antimicrobial efficacy, cost and solubility place practical constraints on the levels that can be used.

The composition of the present invention contains a surfactant selected from anionic surfactant, non-ionic surfactant, and mixtures thereof.

The anionic surfactants include, for example, alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds comprise a carbon chain containing 12 to 20 carbon atoms.

Examples of the foregoing anionic surfactants are available under the following tradenames: RHODAPON, STEPANOL, HOSTAPUR, SURFINE, SANDOPAN, NEODOX, BIOSOFT, and AVANEL. Examples of desirable anionic surfactants include sodium dodecylbenzene sulfonate (e.g., Bio-Soft D40®, Stepan Company, Northfield, Ill.) and sodium lauryl sulfate (Stepanal WAC, Stepan).

Nonlimiting examples of suitable nonionic surfactants which may be used in the present invention are as follows:

(1) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with from about 4 to about 9.5 moles of ethylene oxide per mole of nonyl phenol (examples such as Macol NP-4 (4 moles of EO; HLB of 8.8), Macol NP-6 (6 moles of EO; HLB of 10.8), Macol NP-9.5 (9.5 moles of EO; HLB of 13.0) from Mazer Chemicals, Inc., Triton N-57 (HLB of 10.0) and Triton N-42 (HLB of 9.1) from Rohm & Haas Co., Igepal CO-520 (HLB of 10.0) from GAF Chemicals Corp., Alkasurf NP-5 (HLB of 10.0) and Alkasurf NP-4 (HLB of 9.0) from Alkaril Chemicals, Surfonic N-40 (HLB of 8.9) from Huntsman Chemical, such as; those from the Triton series from Rohm & Haas Co., such as Triton N-101 (9-10 moles of EO; HLB of 13.4) and Triton N-111 (HLB of 13.8); polyethoxylated nonylphenols, such as those from the Igepal series from GAF Chemicals Corp., such as Igepal CO-530 (HLB of 10.8), Igepal CO-730 (HLB of 15.0), Igepal CO-720 (HLB of 14.2), Igepal CO-710 (HLB of 13.6), Igepal CO-660 (HLB of 13.2), Igepal CO-620 (HLB of 12.6) and Igepal CO-610 (HLB of 12.2); those from the Alkasurf series from Alkaril Chemicals, such as Alkasurf NP-6 (HLB of 11.0), Alkasurf NP-15 (HLB of 15.0), Alkasurf NP-12 (HLB of 13.9), Alkasurf NP-11 (HLB of 13.8), Alkasurf NP-10 (HLB of 13.5), Alkasurf NP-9 (HLB of 13.4), and Alkasurf NP-8 (HLB of 12.0); and those from the Surfonic series from Huntsman Chemical Company, such as Surfonic N-60 (HLB of 10.9), Surfonic N-120 (HLB of 14.1); Surfonic N-102 (HLB of 13.5); Surfonic N-100 (HLB 13.3); Surfonic N-95 (HLB of 12.9); and Surfonic N-85 (HLB of 12.4), Tergitol NP-9 and further examples, such as those provided in McCutcheon's Emulsifiers and Detergents, 2001 referenced herein and); dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

(2) The condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. Examples include Alfonic® 810-4.5 (also available as Teric G9A5), which is described in product literature from Sasol as a C₈₋₁₀ having an average molecular weight of 356, an ethylene oxide content of about 4.85 moles (about 60 wt. %), and an HLB of about 12; Alfonic® 810-2, which is described in product literature from Sasol as a C₈₋₁₀ having an average molecular weight of 242, an ethylene oxide content of about 2.1 moles (about 40 wt. %), and an HLB of about 12; and Alfonic® 610-3.5, which is described in product literature from Sasol as having an average molecular weight of 276, an ethylene oxide content of about 3.1 moles (about 50 wt. %), and an HLB of 10. Product literature from Sasol also identifies that the numbers in the alcohol ethoxylate name designate the carbon chain length (numbers before the hyphen) and the average moles of ethylene oxide (numbers after the hyphen) in the product.

Other examples of alcohol ethoxylates are C₁₀ oxo-alcohol ethoxylates available from BASF under the Lutensol ON tradename. They are available in grades containing from about 3 to about 11 moles of ethylene oxide (available under the names Lutensol ON 30; Lutensol ON 50; Lutensol ON 60; Lutensol ON 65; Lutensol ON 66; Lutensol ON 70; Lutensol ON 80; and Lutensol ON 110).

Other examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule.

Further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9;—where R is linear C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol UD series from Clariant, described as tradenames Genapol UD 030, C₁₁-Oxo-alcohol polyglycol ether with 3 EO; Genapol UD, 050 C₁₁-Oxo-alcohol polyglycol ether with 5 EO; Genapol UD 070, C₁₁-Oxo-alcohol polyglycol ether with 7 EO; Genapol UD 080, C₁₁-Oxo-alcohol polyglycol ether with 8 EO; Genapol UD 088, C₁₁-Oxo-alcohol polyglycol ether with 8 EO; and Genapol UD 110, C₁₁-Oxo-alcohol polyglycol ether with 11 EO.

Other examples include those surfactants having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename. available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1,26-L-1.6, 26-L-2,26-L-3,26-L-5,26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3,24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

(3) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

Another group of nonionic surfactants containing the characteristic alkylene oxide blocks are those which may be generally represented by the formula (A):
HO-(EO)ₓ(PO)_{y}(EO)_{z}—H (A)
where
EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants can be represented by the formula (B):
R-(EO,PO)ₐ(EO,PO)_{b}—H (B)
wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further nonionic surfactants containing polymeric butoxy (BO) groups can be represented by formula (C) as follows:
RO-(BO)ₙ(EO)ₓ—H (C)
wherein
R is an alkyl group containing 1 to 20 carbon atoms,
n is about 5-15 and x is about 5-15.

Additional nonionic block copolymer surfactants, which also include polymeric butoxy groups, are those which may be represented by the following formula (D):
HO-(EO)ₓ(BO)ₙ(EO)_{y}—H (D)
wherein
n is about 5-15, preferably about 15,
x is about 5-15, preferably about 15, and
y is about 5-15, preferably about 15.

Still further nonionic block copolymer surfactants include ethoxylated derivatives of propoxylated ethylene diamine, which may be represented by the following formula: 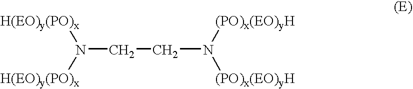
where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Another example of a non-ionic surfactant is an amine oxide; examples of amine oxide compounds include one or more of the following of the four general classes:
(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;
(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis-(2-hydroxyethyl) tallowamine oxide; and bis-(2-hydroxyethyl) stearylamine oxide;
(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
(4) Alkylmorpholine oxides in which the alkyl group has about 10-20, and preferably 12-16 carbon atoms, and can be straight or branched chain, saturated or unsaturated.

While these amine oxides recited above may be used, preferred are amine oxides which may be represented by the following structural representation: 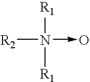
wherein
each R₁ independently is a straight chained C₁-C₄ alkyl group; and,
R₂ is a straight chained C₆-C₂₂ alkyl group or an alkylamidoalkylene having the formula 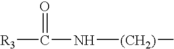
where R₃ is C₅-C₂₀ alkyl or
   —(CH₂)ₚ—OH
where n is 1 to 5 and p is 1 to 6; additionally, R₂ or R₃ could be ethoxylated (1 to 10 moles EO/mol) or propoxylated (1 to 10 moles of PO/mol).

Each of the alkyl groups may be linear or branched, but most preferably are linear. Examples include Ammonyx® LO which is described to be as a 30% wt. active solution of lauryl dimethyl amine oxide; Ammonyx® CDO Special, described to be a about 30% wt. active solution of cocoamidopropylamine oxide, as well as AmmonyxE MO, described to be a 30% wt. active solution of myristyldimethylamine oxide, all available from Stepan Company (Northfield, Ill.) with similar materials also available from Lonza under the Barlox trademark.

The surfactant selected from anionic surfactant, non-ionic surfactant and mixtures thereof is present in the compositions of the present invention in an amount of from about 0.01 to about 20% by weight, more preferably from about 0.1 to about 10% by weight.

A solvent selected from alcohol, glycol ethers, and mixtures thereof is another component of the present invention. Examples include C1-C8 alcohols, glycol ethers, and mixtures thereof. Examples of C1 to C8 alcohols include ethanol, propanol, isopropanol, hexanol, and benzyl alcohol. Examples of glycol ethers include propylene glycol phenyl ether, propylene glycol methyl ether, dipropylene glycol methyl ether, tripropylene glycol methyl ether, propylene glycol n-propyl ether, diethylene glycol methyl ether, ethylene glycol butyl ether, diethylene glycol methyl ether, ethylene glycol monohexyl ether, and mixtures thereof.

Thickeners useful in the present invention to achieve this viscosity are selected from the group consisting of polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gum, locust bean gum, tragacanth gum, or derivatives thereof, polycarboxylate polymers, polyacrylamides, clays, and mixtures thereof.

Examples of the cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose.

Examplary polycarboxylate polymers thickeners have a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

The polycarboxylate polymer can be a non-associative thickener or stabilizer, such as a homopolymer or a copolymer of an olefinically unsaturated carboxylic acid or anhydride monomers containing at least one activated carbon to carbon olefinic double bond and at least one carboxyl group or an alkali soluble acrylic emulsion, or an associative thickener or stabilizer, such as a hydrophobically modified alkali soluble acrylic emulsion or a hydrophobically modified nonionic polyol polymer, i.e., a hydrophobically modified urethane polymer, or combinations thereof. The copolymers are preferably of a polycarboxylic acid monomer and a hydrophobic monomer. The preferred carboxylic acid is acrylic acid. The homopolymers and copolymers preferably are crosslinked.

Homopolymers of polyacrylic acid are described, for example, in U.S. Pat. No. 2,798,053. Examples of homopolymers which are useful include Carbopol® 934, 940, 941, Ultrez 10, ETD 2050, and 974P polymers, which are available from Noveon. Such polymers are homopolymers of unsaturated, polymerizable carboxylic monomers such as acrylic acid, methacrylic acid, maleic acid, itaconic acid, maleic anhydride, and the like.

Hydrophobically modified polyacrylic acid polymers are described, for example, in U.S. Pat. Nos. 3,915,921, 4,421,902, 4,509,949, 4,923,940, 4,996,274, 5,004,598, and 5,349,030. These polymers have a large water-loving hydrophilic portion (the polyacrylic acid portion) and a smaller oil-loving hydrophobic portion (which can be derived from a long carbon chain acrylate ester). Representative higher alkyl acrylic esters are decycl acrylate, lauryl acrylate, stearyl acrylate, behenyl acrylate and melissyl acrylate, and the corresponding methacrylates. It should be understood that more than one carboxylic monomer and more than one acrylate ester or vinyl ester or ether or styrenic can be used in the monomer charge. The polymers can be dispersed in water and neutralized with base to thicken the aqueous composition, form a gel, or emulsify or suspend a deliverable. Useful polymers are sold as Carbopol® 1342 and 1382 and Pemulen® TR-1, TR-2, 1621, and 1622, all available from Noveon. The carboxyl containing polymers are prepared from monomers containing at least one activated vinyl group and a carboxyl group, and would include copolymers of polymerizable carboxylic monomers with acrylate esters, acrylamides, alkylated acrylamides, olefins, vinyl esters, vinyl ethers, or styrenics. The carboxyl containing polymers have molecular weights greater than about 500 to as high as several billion, or more, usually greater than about 10,000 to 900,000 or more.

Also useful are interpolymers of hydrophobically modified monomers and steric stabilizing polymeric surface active agents having at least one hydrophilic moiety and at least one hydrophobic moiety or a linear block or random comb configuration or mixtures thereof. Examples of steric stabilizers which can be used are Hypermer®, which is a poly(12-hydroxystearic acid) polymer, available from Imperial Chemical Industries Inc. and Pecosil®, which is a methyl-3-polyethoxypropyl siloxane-ω-phosphate polymer, available from Phoenix Chemical, Somerville, N.J. These are taught by U.S. Pat. Nos. 4,203,877 and 5,349,030, the disclosures of which are incorporated herein by reference.

The polymers can be crosslinked in a manner known in the art by including, in the monomer charge, a suitable crosslinker in amount of about 0.1 to 4%, preferably 0.2 to 1% by weight based on the combined weight of the carboxylic monomer and the comonomer(s). The crosslinker is selected from polymerizable monomers which contain a polymerizable vinyl group and at least one other polymerizable group. Polymerization of the carboxyl-containing monomers is usually carried out in a catalyzed, free radical polymerization process, usually in inert diluents, as is known in the art.

Other polycarboxylic acid polymer compositions which can be employed include, for example, crosslinked copolymers of acrylates, (meth)acrylic acid, maleic anhydride, and various combinations thereof. Commercial polymers are available from Rheox Inc., Highstown, N.J. (such as Rheolate® 5000 polymer), 3 V Sigma, Bergamo, Italy (such as Stabelyn® 30 polymer, which is an acrylic acid/vinyl ester copolymer, or Polygel® and Synthalen® polymers, which are crosslinked acrylic acid polymers and copolymers), Noveon (such as Carbopol 674 (lightly crosslinked polyacrylate polymer), Carbopol 676 (highly crosslinked polyacrylate polymer), Carbopol EP-1 thickener, which is a acrylic emulsion thickener), or Rohm and Haas (such as Acrysol® ICS-1 and Aculyn® 22 thickeners, which are hydrophobically modified alkali-soluble acrylic polymer emulsions and Aculyn® 44 thickener, which is a hydrophobically modified nonionic polyol). Preferred are the Carbopol® and Pemulen® polymers, generally. The choice of the specific polymer to be employed will depend upon the desired rheology of the composition, and the identity of other compositional ingredients.

Clay thickeners comprise, for example, colloid-forming clays, for example, such as smectite and/or attapulgite types. The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

Smectites are three-layered clays. There are two distinct classes of smectite-type clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas may vary with the processing to which the clay has been subjected.

Commercially available clays include, for example, montmorillonite, bentonite, volchonskoite, nontronite, beidellite, hectorite, saponite, sauconite and vermiculite. The clays herein are available under various trade names such as Gelwhite GP, Gelwhite H, Mineral Colloid BP, and Laponite from Southern Clay Products, Inc., Texas; and Van Gel O from R. T. Vanderbilt. Gelwhite H—NF has a typical chemical analysis of SiO₂ 66.5%; Al₂O₃ 14.7%; MgO 3.2%; Fe₂O₃ 0.8%; CaO 2.2%; Na₂O 3.3%; K₂O 0.1%; TiO₂ 0.2%. Gelwhite L-NF has a typical chemical analysis of SiO₂ 66.5%; Al₂O₃ 14.7%; MgO 0.3.2%; Fe₂O₃ 0.8%; CaO 2.2%; Na₂O 3.3%; K₂O 0.1%; TiO₂ 0.2%. Gelwhite GP has a typical chemical analysis of SiO₂ 66.5%; Al₂O₃ 14.7%; MgO 3.2%; Fe₂O₃ 0.8%; CaO 2.2%; Na₂O 3.3%; K₂O 0.1%; TiO₂ 0.2%. Mineral Colloid BP has a typical chemical analysis of SiO₂ 62.9%; Al₂O3 17.1%; MgO 2.4%; Fe₂O₃ 4.8%; CaO 0.7%; Na₂O 2.1%; K₂O 0.2%; TiO₂ 0.1%.

A second type of expandable clay material useful in the instant invention is classified geologically as attapulgite (polygorskite). Attapulgites are magnesium-rich clays having principles of superposition of tetrahedral and octahedral unit cell elements different from the smectites. A typical attapulgite analyses yields 55.02% SiO₂; 10.24% Al₂O₃; 3.53% Fe₂O₃; 10.45% MgO; 0.47% K₂O; 9.73% H₂O removed at 150° C.; 10.13% H₂O removed at higher temperatures. Like the smectites, attapulgite clays are commercially available. For example, such clays are marketed under the tradename Attagel, i.e. Attagel 40, Attagel 50 and Attagel 150 from Engelhard Minerals & Chemicals Corporation.

The preferred clay thickeners comprise the inorganic, colloid forming clays of smectite and/or attapulgite types. Preferred clays include products from Vanderbilt Chemical Company such as VanGel O.

The amount of thickener used in the present invention can range from about 0.1 to 10 wt %.

The present invention also comprises a abrasive material selected from the group consisting of oxides (for example, calcined aluminum oxides and the like), carbonates (for example, calcium carbonate and the like), quartzes, siliceous chalk, diatomaceous earth, colloidal silicon dioxide, alkali metasilicates (for example, sodium metasilicate and the like), perlite, pumice, feldspar, triploi, and calcium phosphate, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials such as, for example, rice hulls, corn cobs, and the like, or talc and mixtures thereof. The particle size of the abrasive agent can range from about 1 μm to about 1000 μm, preferably between about 10 μm to about 200 μm, and more preferably between about 10 μm and about 100 μm. It is preferred to us those abrasive agents that will not scratch glass ceramic surfaces. Such abrasive agents include calcium carbonate, siliceous chalk, diatomaceous earth, colloidal silicon dioxide, sodium metasilicate, talc, and organic abrasive materials. Calcium carbonate is preferred.

The abrasive material is generally present in an amount of from about 1 to about 40% wt.

Water is added to the above constituents in order to provide 100% by weight of the composition. The water may be tap water, but is preferably distilled and is most preferably deionized water. If the water is tap water, it is preferably substantially free of any undesirable impurities such as organics or inorganics, especially mineral salts which are present in hard water which may interact with the other components of the inventive compositions.

### EXAMPLES

Preparation of Example Formulations:

Exemplary formulations illustrating certain embodiments of the inventive compositions and described in more detail in Table 1 below were formulated generally in accordance with the following protocol.

Into a suitably sized vessel, a measured amount of water was provided after which the remaining constituents were added. Mixing, which generally lasted from 5 minutes to 120 minutes was maintained until the particular formulation appeared to be homogeneous. The exemplary compositions were readily pourable, and retained well mixed characteristics (i.e., stable mixtures) upon standing for extended periods.

Examples of inventive formulations are shown in Table 1 below.

TABLE 1

| | Ex. 1 | Ex. 2 | Ex. 3 | Ex. 4 | Ex. 5 |
|---|---|---|---|---|---|
| Kelzan ASX | 0.06 | 0.06 | | 0.06 | |
| Kelzan AR | | | | | 0.50 |
| Carbopol 674 | 0.10 | 0.10 | 0.17 | 0.10 | |
| Clay 342SC | 0.80 | 0.80 | 1.00 | | |
| Gelwhite H NF | | | | 0.80 | 0.80 |
| NaOH | 0.25 | 0.25 | 0.25 | 0.25 | |
| Sodium carbonate | | | | | 0.50 |
| Benzyl alcohol | 2.00 | | | | |
| Dowanol PPH | | 2.00 | 2.00 | | |
| Hexyl Cellosolve | | | | 1.50 | 1.00 |
| Calcium carbonate | 16.00 | 16.00 | 16.00 | 16.00 | 16.00 |
| EDTA | | | 0.38 | | |
| Tergitol NP-9 | | | 3.00 | 2.00 | 2.00 |
| Tergitol NP-4 | 3.00 | 3.00 | | | |
| SLS | 0.90 | 0.90 | 0.90 | | |
| NaDDBS | | | | 1.20 | 0.80 |
| Fragrance | 0.30 | 0.20 | 0.20 | | 0.30 |
| Water | q.s. | q.s. | q.s. | q.s. | q.s. |

The components used to make the formulations found in Table 1 are described in Table 2, following

TABLE 2

| | Description |
|---|---|
| Kelzan ASX | Xanthan gum, Kelco |
| Kelzan AR | Xanthan gum, Kelco |
| Carbopol 674 | lightly cross-linked polyacrylate polymer, Noveon |
| Clay 342SC | Clay, ex. Southern Clay Products |
| Gelwhite H NF | Montmorillonite, Southern Clay Products |
| NaOH | Sodium hydroxide |
| Sodium carbonate | Sodium carbonate |
| Benzyl alcohol | Benzyl alcohol |
| Dowanol PPH | Propylene glycol phenyl ether, Dow Chemical |
| Hexyl Cellosolve | Ethylene glycol monohexyl ether, Dow Chemical |
| Calcium carbonate | Calcium carbonate |
| EDTA | Ethylenediaminetetraacetic acid, tetrasodium salt |
| Tergitol NP-9 | Nonylphenoxy ethoxylate |
| Tergitol NP-4 | Nonylphenoxy ethoxylate |
| SLS | Sodium lauryl sulfate |
| NaDDBS | Sodium dodecylbenzesulfonate |
| Fragrance | Fragrance |
| Water | Deionized water |

The formulations of Table 1 evaluated against Salmonella choleraesuis and Psuedomonas aeruginosa at a five (5) minute contact time. The results (in log₁₀ reduction) are shown in Table 3.

TABLE 3

| | Ex. 1 | Ex. 2 | Ex. 3 | Ex. 4 | Ex. 5 |
|---|---|---|---|---|---|
| Salmonella choleraesuis | 5.58 | 4.64 | 4.69 | 1.00 | 5.58 |
| Psuedomonas aeruginosa | 5.31 | 5.31 | 3.33 | 6.76 | 5.31 |

1. A liquid cleaning and disinfecting composition comprising:
an alkaline source;
at least one anionic surfactant;
at least one clay thickener with at least one further thickener selected from polysaccharides, polycarboxylates, and polyacrylamides;
a solvent selected from alcohols, glycol ethers, and mixtures thereof;
at least one abrasive material selected from oxides, carbonates, quartzes, siliceous chalk, diatomaceous earth, colloidal silicon dioxide, alkali metasilicates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or talc and mixtures thereof;
water; and
optionally, one or more materials selected from further surfactants, perfumes and perfume stabilizers, builders, rheology stabilizers; pH and buffering agents, electrolytes, pigments, and colorants.

2. The composition according to claim 1 wherein the alkaline source is selected from alkaline metal hydroxides, carbonates, bicarbonates, and mixtures thereof.

3. The composition according to claim 1 wherein the thickener is a mixture of polysaccharide and clay.

4. The composition according to claim 1 wherein the thickener is a mixture of polycarboxylate and clay.

5. The composition according to claim 1 wherein the polysaccharide thickener is selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, xanthan gum, guar gum, locust bean gum, tragacanth gum, or derivatives thereof.

6. The composition according to claim 1 wherein the solvent is an alcohol.

7. The composition according to claim 6 wherein the alcohol is benzyl alcohol.

8. The composition according to claim 1 wherein the solvent is a glycol ether.

9. The composition according to claim 8 wherein the glycol ether is selected from propylene glycol phenyl ether and ethylene glycol monohexyl ether.

10. The composition according to claim 1 wherein the abrasive material is a carbonate.

11. A liquid cleaning and disinfecting composition comprising:
from about 0.01 to about 2 wt % of an alkaline source;
from about 0.01 to about 20 wt % of at least one anionic surfactant;
from about 0.1 to about 10 wt % of at least one clay thickener with at leaset one further thickener selected from polysaccharides, polycarboxylates, polyacrylamides;
from about 0.1 to about 10 wt % of a solvent selected from alcohols, glycol ethers, and mixtures thereof;
from about 1 to about 40 wt % of at least one abrasive material selected from oxides, carbonates, quartzes, siliceous chalk, diatomaceous earth, colloidal silicon dioxide, alkali metasilicates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or talc and mixtures thereof;
water; and
optionally, one or more materials selected from further surfactants, perfumes and perfume stabilizers, builders, rheology stabilizers; pH and buffering agents, electrolytes, pigments, and colorants.

12. The composition according to claim 11 wherein the alkaline source is selected from alkaline metal hydroxides, carbonates, bicarbonates, and mixtures thereof.

13. The composition according to claim 11 wherein the thickener is a mixture of polysaccharide and clay.

14. The composition according to claim 11 wherein the thickener is a mixture of polycarboxylate and clay.

15. The composition according to claim 11 wherein the polysaccharide thickener is selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, xanthan gum, guar gum, locust bean gum, tragacanth gum, or derivatives thereof.

16. The composition according to claim 11 wherein the solvent is an alcohol.

17. The composition according to claim 16 wherein the alcohol is benzyl alcohol.

18. The composition according to claim 11 wherein the solvent is a glycol ether.

19. The composition according to claim 18 wherein the glycol ether is selected from propylene glycol phenyl ether and ethylene glycol monohexyl ether.

20. The composition according to claim 11 wherein the abrasive material is a carbonate.
